(19) United States
(12) Patent Application Publication
(10) Pub. No.: US 2019/0324685 A1
(43) Pub. Date: Oct. 24, 2019

(54) STORAGE MANAGEMENT SYSTEM AND METHOD

(71) Applicant: EMC IP Holding Company, LLC, Hopkinton, MA (US)

(72) Inventors: JUSTIN L. HA, Hayward, CA (US); Frederick Kwan Hang Lee, Mountain View, CA (US)

(21) Appl. No.: 15/957,132

(22) Filed: Apr. 19, 2018

(51) Int. Cl. G06F 3/06

(52) U.S. Cl. CPC G06F 3/0659; G06F 3/067; G06F 3/0611

(57) ABSTRACT

A method, computer program product, and computing system for receiving a request concerning a load change event impacting at least one list defined for a storage device. The load change event is processed and a load statistic associated with the at least one list defined for the storage device is recalculated.

### TECHNICAL FIELD

This disclosure relates to storage management systems and, more particularly, to storage management systems that increase the efficiency of data storage operations.

### BACKGROUND

Storing and safeguarding electronic content is of paramount importance in modern business. Accordingly, various methodologies may be employed to protect and distribute such electronic content, wherein the storage systems that process such content may strive to do so in as an efficient manner as possible. Unfortunately and due to inherent limitations in some of the memory technology utilized in such storage systems, complex methodologies may need to be utilized in order to navigate around such inherent shortcomings.

### SUMMARY OF DISCLOSURE

In one implementation, a computer-implemented method is executed on a computing device and includes receiving a request concerning a load change event impacting at least one list defined for a storage device. The load change event is processed and a load statistic associated with the at least one list defined for the storage device is recalculated.

One or more of the following features must be included. Processing the load change event may include disassociating a data stream from a first list. Recalculating a load statistic may include recalculating a load statistic for the first list to remove the impact of the data stream. Processing the load change event may include selecting a second list and associating a data stream with the second list. Recalculating a load statistic may include recalculating a load statistic for the second list to add the impact of the data stream. Processing the load change event may include moving of an existing stream associated with a first list to a new target. Recalculating a load statistic may include recalculating a load statistic for the first list to remove the impact of the existing data stream; selecting a new target; and recalculating a load statistic for the second list to add the impact of the existing data stream.

In another implementation, a computer program product resides on a computer readable medium and has a plurality of instructions stored on it. When executed by a processor, the instructions cause the processor to perform operations including receiving a request concerning a load change event impacting at least one list defined for a storage device. The load change event is processed and a load statistic associated with the at least one list defined for the storage device is recalculated.

One or more of the following features must be included. Processing the load change event may include disassociating a data stream from a first list. Recalculating a load statistic may include recalculating a load statistic for the first list to remove the impact of the data stream. Processing the load change event may include selecting a second list and associating a data stream with the second list. Recalculating a load statistic may include recalculating a load statistic for the second list to add the impact of the data stream. Processing the load change event may include moving of an existing stream associated with a first list to a new target. Recalculating a load statistic may include recalculating a load statistic for the first list to remove the impact of the existing data stream; selecting a new target; and recalculating a load statistic for the second list to add the impact of the existing data stream.

In another implementation, a computing system includes a processor and memory is configured to perform operations including receiving a request concerning a load change event impacting at least one list defined for a storage device. The load change event is processed and a load statistic associated with the at least one list defined for the storage device is recalculated.

One or more of the following features must be included. Processing the load change event may include disassociating a data stream from a first list. Recalculating a load statistic may include recalculating a load statistic for the first list to remove the impact of the data stream. Processing the load change event may include selecting a second list and associating a data stream with the second list. Recalculating a load statistic may include recalculating a load statistic for the second list to add the impact of the data stream. Processing the load change event may include moving of an existing stream associated with a first list to a new target. Recalculating a load statistic may include recalculating a load statistic for the first list to remove the impact of the existing data stream; selecting a new target; and recalculating a load statistic for the second list to add the impact of the existing data stream.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a storage system and a storage management process coupled to a distributed computing network;

FIG. 2 is a diagrammatic view of the storage system of FIG. 1;

FIG. 3 is a diagrammatic view of a storage device for use with the storage system of FIG. 2;

FIG. 4 is a first update timeline for use by the storage management process of FIG. 1;

FIG. 5 is a flow chart of the storage management process of FIG. 1;

FIG. 6 is a second update timeline for use by the storage management process of FIG. 1;

FIG. 7 is a third update timeline for use by the storage management process of FIG. 1; and

FIG. 8 is a fourth update timeline for use by the storage management process of FIG. 1.

Like reference symbols in the various drawings indicate like elements.

### DETAILED DESCRIPTION OF THE PREFERRED EMBODIMENTS

### System Overview:

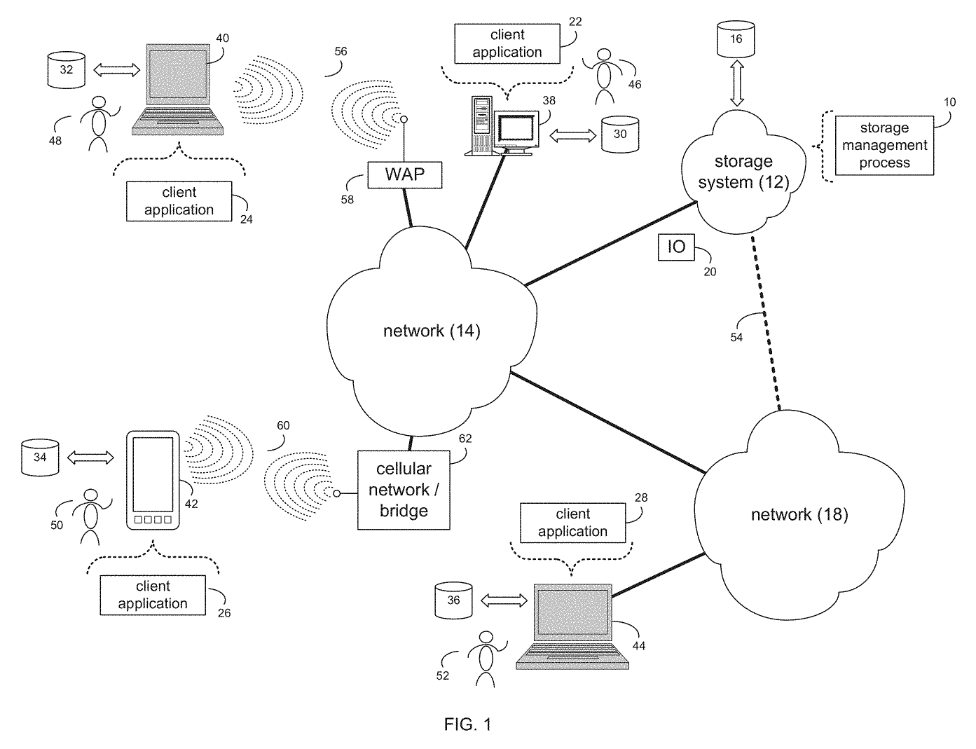

Referring to FIG. 1, there is shown storage management process 10 that may reside on and may be executed by storage system 12, which may be connected to network 14 (e.g., the Internet or a local area network). Examples of storage system 12 may include, but are not limited to: a personal computer with a memory system, a server computer with a memory system, a Network Attached Storage (NAS) system, a Storage Area Network (SAN) and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft Windows Server™; Redhat Linux™, Unix, or a custom operating system, for example.

The instruction sets and subroutines of storage management process 10, which may be stored on storage device 16 coupled to storage system 12, may be executed by one or more processors (not shown) and one or more memory architectures (not shown) included within storage system 12. Storage device 16 may include but is not limited to: a hard disk drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (i.e. a request that content be written to storage system 12) and data read requests (i.e. a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices (e.g., client electronic devices 38, 40, 42, 44) may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft Windows™, Apple Macintosh™, Redhat Linux™, or a custom operating system.

### The Data Storage System:

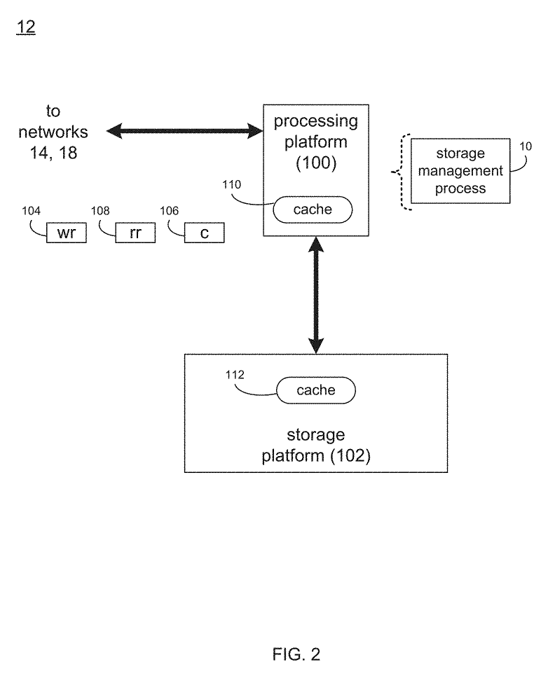

Referring also to FIG. 2, there is shown a general implementation of storage system 12. In this general implementation, storage system 12 may include processing platform 100, wherein processing platform 100 may be configured to perform computational tasks and may be configured to store data within storage platform 102.

Depending on the manner in which storage system 12 is configured, storage platform 102 may include a single storage device (such as a single hard disk drive or a single solid state storage device) or may include a plurality of storage devices that are configured to provide various levels of performance and/or high availability. For example and if storage platform 102 includes a plurality of storage devices (e.g., hard disk drives and/or solid state storage devices), this plurality of storage devices may be configured to form a RAID array utilizing various standard RAID structures (e.g., RAID 0, RAID 1, RAID 3, RAID 5, RAID 6, RAID 7 or RAID 10), thus providing a higher level of performance and/or availability.

Storage system 12 may be configured to execute all or a portion of storage management process 10. The instruction sets and subroutines of storage management process 10, which may be stored on a storage device (e.g., storage device 16) coupled to processing platform 100, may be executed by one or more processors (not shown) and one or more memory architectures (not shown) included within processing platform 100. Storage device 16 may include but is not limited to: a hard disk drive; a RAID device; a random access memory (RAM); a read-only memory (ROM); and all forms of flash memory storage devices.

As discussed above, various IO requests (e.g. IO request 20) may be generated. For example, these IO requests may be sent from client applications 22, 24, 26, 28 to storage system 12. Additionally/alternatively and when storage system 12 is configured as an application server, these IO requests may be internally generated within storage system 12. Examples of IO request 20 may include but are not limited to data write request 104 (i.e. a request that content 106 be written to storage system 12) and data read request 108 (i.e. a request that content 106 be read from storage system 12).

During operation of processing platform 100, content 106 to be written to storage system 12 may be processed by processing platform 100. Additionally/alternatively and when storage system 12 is configured as an application server, content 106 to be written to storage system 12 may be internally generated by processing platform 100.

Processing platform 100 may include cache memory system 110. Examples of cache memory system 110 may include but are not limited to a volatile, solid-state, cache memory system (e.g., a dynamic RAM cache memory system) and/or a non-volatile, solid-state, cache memory system (e.g., a flash-based, cache memory system). Processing platform 100 may initially store content 106 within cache memory system 110. Depending upon the manner in which cache memory system 110 is configured, processing platform 100 may immediately write content 106 to storage platform 102 (if cache memory system 110 is configured as a write-through cache) or may subsequently write content 106 to storage platform 102 (if cache memory system 110 is configured as a write-back cache).

Storage platform 102 may include cache memory system 112. Examples of cache memory system 112 may include but are not limited to a volatile, solid-state, cache memory system (e.g., a dynamic RAM cache memory system) and/or a non-volatile, solid-state, cache memory system (e.g., a flash-based, cache memory system). During operation of storage platform 102, content 106 to be written to storage platform 102 may be received from processing platform 100. Storage platform 102 may initially store content 106 within cache memory system 112 prior to being stored on e.g. the one or more of storage devices included within storage platform 102.

For the following discussion, storage management process 10 is described as controlling the manner in which data (e.g., content 106) is written to and/or read from the various memory devices/memory systems included within storage system 12. Accordingly, the following discussion may concern the manner in which storage management process 10 controls the writing of data to (and/or the reading of data from) storage platform 102, the writing of data to (and/or the reading of data from) cache memory system 110, and/or the writing of data to (and/or the reading of data from) cache memory system 112.

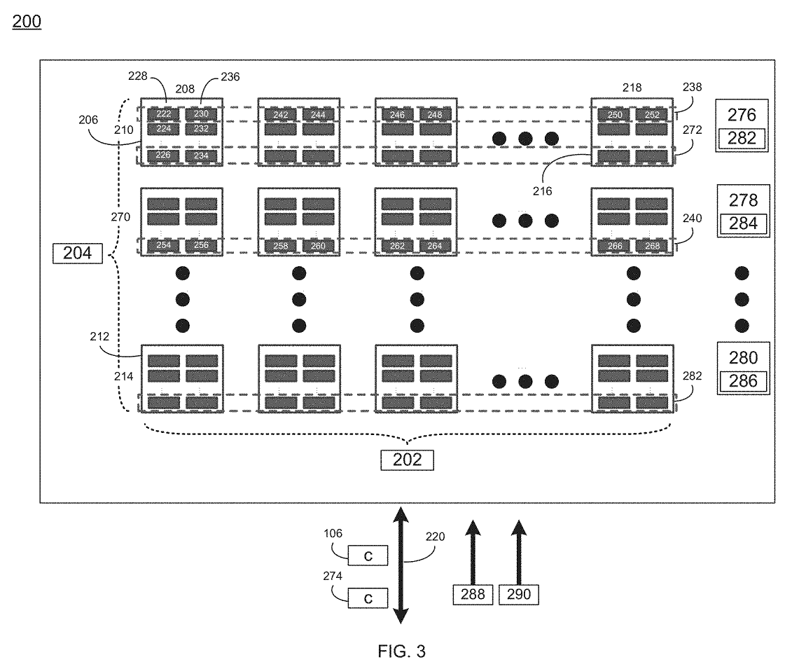

Referring also to FIG. 3, there is shown storage device 200 (e.g., all or a portion of storage platform 102, cache memory system 110 and/or cache memory system 112) to which storage management process 10 may write content 106 (or from which storage management process 10 may read content 106). One example of storage device 200 may include but is not limited to a solid state storage device (e.g., an SSD memory system), such as a flash storage device. Storage device 200 may be divided into a plurality of storage units (e.g., LUNS) that are located via columns (e.g., column 202) and rows (e.g., row 204) to form an array of LUNs. For example, storage device 200 may include 32 columns and 16 rows, resulting in 512 storage units (e.g., LUNS). Specifically, LUN 206 is shown being located @ Column 208/Row 210; while LUN 212 is shown being located @ Column 208/Row 214; and LUN 216 is located @ Column 218/Row 210. Storage device 200 may be coupled to e.g., processing platform 100 via data bus 220, an example of which may include but is not limited to a PCIe data bus.

Each LUN (e.g., LUNs, 206, 212, 216) may include a plurality of memory blocks that may be arranged in a plurality of planes. For example, LUN 206 may include thirty-two memory blocks, where a first group of sixteen memory blocks (e.g., memory blocks 222, 224 . . . 226) are located in plane 228 and a second group of sixteen memory blocks (e.g., memory blocks 230, 232 . . . 234) are located in plane 236. In order to enhance efficiency, when writing data to these memory blocks (e.g., memory blocks 222, 224, 226, 230, 232, 234) within the various LUNs (e.g., LUN 206) of storage device 200, data may be written in unit write operations that span multiple LUNs across multiple columns, thus allowing a group of memory blocks to be processed in one memory operation. An example of such a unit write operation may include a grid block unit write operation, wherein all of the memory blocks within a grid block (e.g., grid block 238 or grid block 240) may be processed in one memory operation.

For example, grid blocks 238, 240 are shown to span all “common-block-identifier” memory blocks (i.e., memory blocks within a LUN that have the same block identifier) for all of the LUNs in a particular row. Specifically, grid block 238 is shown to span all “Block Identifier 0” memory blocks (e.g., memory blocks 222, 230, 242, 244, 246, 248, 250, 252) for all of the LUNs in the group (e.g., row 210), while grid block 240 is shown to span all “Block Identifier 15” memory blocks (e.g., memory blocks 254, 256, 258, 260, 262, 264, 266, 268) for all of the LUNs in the group (e.g., row 270).

Unfortunately, in the event that operations (e.g., write operations and/or read operations) are simultaneously performed on multiple grid blocks within one row, an operation on one grid block may block the operation on another grid block. As discussed above, grid block 238 is positioned within row 210. Further, assume that a second grid block (e.g., grid block 272) is also positioned within row 210. Accordingly, assume that a write operation is being performed to write content 106 to grid block 238 (within row 210). In the event that a second write operation needs to be performed to write content 274 to grid block 272 (also within row 210), this second write operation may be blocked until the first write operation is completed.

Accordingly, grid blocks may be divided into lists to avoid to avoid such operation blocking. As discussed above, LUNs (e.g., LUN 206) may include thirty-two memory blocks, where a first group of sixteen memory blocks (e.g., memory blocks 222, 224 . . . 226) may be located in plane 228 and a second group of sixteen memory blocks (e.g., memory blocks 230, 232 . . . 234) may be located in plane 236. Accordingly and in such a configuration, each die (e.g., dies 210, 214, 270) may contain sixteen grid blocks. And since (as discussed above), blocking events may occur if multiple grid blocks within a common die are simultaneously operated upon, if only one grid block within a list is operated on at a time, such blocking events may be avoided.

Accordingly, a list may be established for each of the dies rows included within storage device 200, wherein each of these lists may define the grid blocks associated with the row. Therefore, list 276 may be established for row 210 that may define the sixteen grid blocks (e.g., grid blocks 238, 272) associated with row 210; while list 278 may be established for row 270 that may define the sixteen grid blocks (e.g., grid block 240) associated with row 270; and list 280 may be established for row 214 that may define the sixteen grid blocks (e.g., grid block 282) associated with row 214.

Each of these lists (e.g., lists 276, 278, 280) may have one or more counters associated with them, wherein these counters may be configured to generally monitor the loading of the grid blocks defined within their respective lists. For example, counter 282 may be indicative of the quantity of data cumulatively read from (and/or cumulatively written to) the grid blocks defined within list 276 and associated with row 210, while counter 284 may be indicative of the quantity of data cumulatively read from (and/or cumulatively written to) the grid blocks defined within list 278 and associated with row 270, and counter 286 may be indicative of the quantity of data cumulatively read from (and/or cumulatively written to) the grid blocks defined within list 280 and associated with row 214.

For example, when defining the quantity of data read from (and/or written to) the grid blocks defined within a specific list and associated with a specific row, this quantity of data may be defined as the sum of the quantity of read operations and/or write operations being performed on (or to) the various grid blocks defined within a particular list and associated with a particular row.

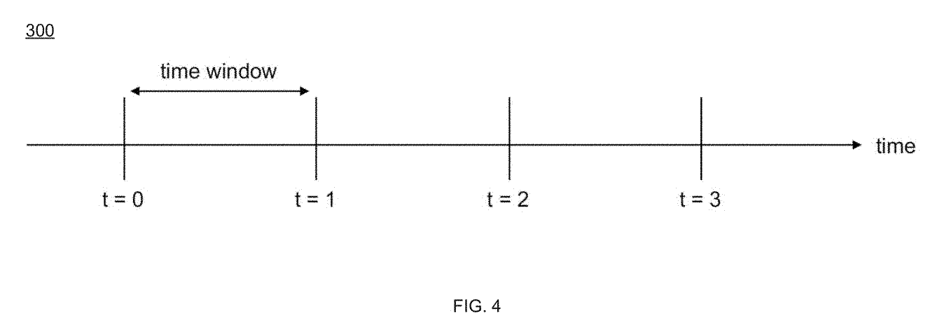

Referring also to FIG. 4, there is shown timeline 300 that may be indicative of the manner in which the various counters (e.g., counters 282, 284, 286) associated with the various lists (e.g., lists 276, 278, 280, respectively) may be updated on a global basis. For example, after a defined time interval (e.g., once per second), the loading of the various lists (e.g., lists 276, 278, 280) by the various streams may be analyzed to define the total number of read operations and/or the total number of write operations being cumulatively performed by the streams associated with each of the counters. One particular non-limiting example of the manner in which such a global update may be performed is as follows: a) read and/or write counters may be defined that quantify the per stream loading of the various lists (e.g., lists 276, 278, 280); b) these per stream read and/or write counters may then be decayed at the time of these global updates; and c) a list counter for one or more specific lists may then be calculated by summing the read and/or write counters for all of the streams that are associated with the one or more specific lists. While this example is quite specific, it is for illustrative purposes only and is not intended to be a limitation of this disclosure or the manner in which e.g., such global updates may be performed, the manner in which aging counter values may be decayed, or the manner in which specific counters may be summed to generate broader counters.

For example, as counter 282 may be indicative of the quantity of data cumulatively read by (and/or cumulatively written by) the streams associated with list 276, counter 282 may define the sum of all of the read operations and/or write operations currently being effectuated by the streams associated with list 276. Further, as counter 284 may be indicative of the quantity of data cumulatively read by (and/or cumulatively written by) the streams associated with list 278, counter 284 may define the sum of all of the read operations and/or write operations currently being effectuated by the streams associated with list 278. Additionally, as counter 286 may be indicative of the quantity of data cumulatively read by (and/or cumulatively written by) the streams associated with list 280, counter 286 may define the sum of all of the read operations and/or write operations effectuated by the streams associated with list 280.

During operation of storage device 200, storage management process 10 may process various data streams while writing data to the memory system (e.g., a data stream to write content 106 to storage device 200). For example, new data streams may be started when the writing of content to a grid block within storage device 200 is initiated, while existing data streams may be ended when the writing of content to a grid block within storage device 200 is completed. Further, when an existing data stream is writing content to a grid block that is eventually filled up, the existing data stream may be moved from the full grid block to a grid block that has storage capacity.

When establishing the above-described counters (e.g., counters 282, 284, 286) that quantify the sum of all of the read operations and/or write operations currently being performed by the grid blocks defined within a specific list (e.g., lists 276, 278, 280), the various data streams acting upon storage device 200 may be monitored. Specifically, a read operation counter (not shown) and a write operation counter (not shown) may be established for each data stream with respect to each list.

For example and for Stream A and List X, a read operation counter (R_{AX}) may quantify that number of read operations being performed by Stream A on (the grid blocks defined within) List X, and a write operation counter W_{AX} may quantify that number of write operations being performed by Stream A on (the grid blocks defined within) List X. Such read operation counters and write operation counters may be established for all streams (acting upon storage device 200) with respect to all lists (defined for storage device 200).

Therefore, in order to determine the total “write load” experienced by e.g., List X, the individual write operation counters associated with List X (regardless of stream) may be summed; while the total “read load” experienced by List Y may be determined by summing the individual read operation counters associated with List Y (regardless of stream). This same methodology may be utilized to determine the total loading (i.e., “read load” & “write load”) experienced by a specific list, or the “read load”, “write load” or “total load” provided by a specific stream.

As discussed above, timeline 300 may be indicative of the manner in which the various counters (e.g., counters 282, 284, 286) associated with the various lists (e.g., lists 276, 278, 280, respectively) may be updated on a global basis. Additionally, when newer calculations are made e.g., @ time T=1 (with respect to time T=0), @ time T=2 (with respect to time T=1), and @ time T=3 (with respect to time T=2); the older calculations need not be totally disregarded and may simply be weighted so that their influence decays over a defined number of time intervals (thus providing a quasi-historical record concerning list utilization). For example and when calculating the various counters (e.g., counters 282, 284, 286 and/or the above-described stream counters), at the time of a global update, the current value of a counter may be decayed by a certain percentage (e.g., 25%, 50% or 75%), wherein the resulting decayed value may be added to the new calculation to e.g., take into account the historical value of the counter(s).

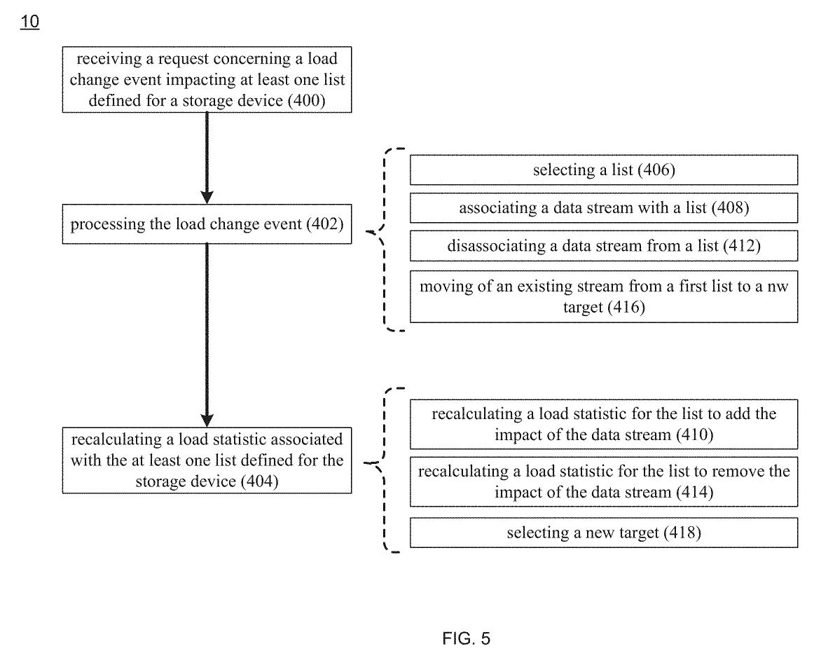

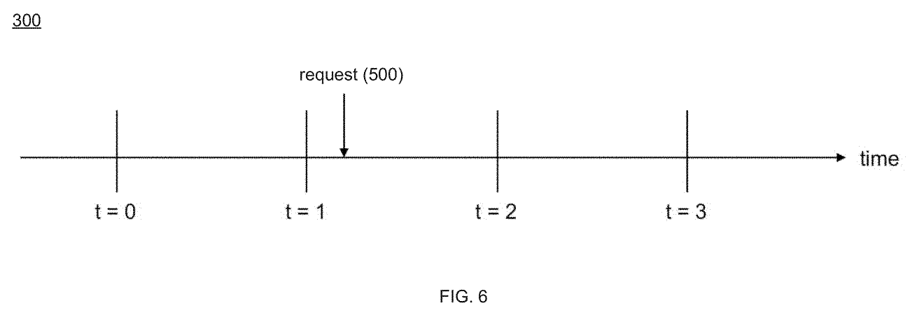

Referring also to FIGS. 5-6 and during operation of storage device 200, storage management process 10 may receive 400 a request (e.g., request 500) concerning a load change event impacting at least one list (e.g., one or more of lists 276, 278, 280) defined for storage device 200. Storage management process 10 may process 402 this load change event and may recalculate 404 a load statistic (e.g., one or more of counters 282, 284, 286) associated with the at least one list (e.g., one or more of lists 276, 278, 280) defined for storage device 200.

Examples of the above-referenced load change events defined within request 500 may include but are not limited to one or more of:
a new data stream starting when the writing of content to a grid block within storage device 200 is initiated,
an existing data stream ending when the writing of content to a grid block within storage device 200 is completed; and
an existing data stream moving from a first grid block to a second grid block when the first grid block fills up.

### A New Data Stream Starting:

For the following example, assume that a new data stream (e.g., data stream 288) is established for the writing of content 106 to storage device 200. Accordingly, storage management process 10 may receive 400 a request (e.g., request 500) concerning this load change event (i.e., the establishment of data stream 288) that may impact at least one list (e.g., one or more of lists 276, 278, 280) defined for storage device 200. Specifically, one or more of the grid blocks defined within at least one list (e.g., one or more of lists 276, 278, 280) may need to process data stream 288 and, therefore, these grid blocks (and the list(s) associated with these grid blocks) may experience a higher level of loading while data stream 288 is processed.

Specifically and when processing 402 the load change event (i.e., the establishment of data stream 288), storage management process 10 may select 406 a list and may associate 408 a data stream with the list. As discussed above, each of the above-described lists (e.g., lists 276, 278, 280) may have one or more counters (e.g., counters 282, 284, 286) associated with them, wherein these counters (e.g., counters 282, 284, 286) may be configured to generally monitor the loading of the grid blocks defined within their respective lists.

Accordingly and upon storage management process 10 receiving 400 request 500 concerning the establishment of data stream 288, storage management process 10 may examine the counters (e.g., counters 282, 284, 286) associated with the above-described lists (e.g., lists 276, 278, 280) to determine the loading of the lists (e.g., lists 276, 278, 280) and, therefore, the loading of the grid blocks defined therein, so that storage management process 10 may select 406 a list that is currently not experiencing a high level of loading. Assume for illustrative purposes that counter 282 indicates that list 276 (and the grid blocks defined therein) are currently the least utilized. Accordingly, storage management process 10 may select 406 list 276 and may associate 408 data stream 288 with list 276 so that a grid block defined therein may service data stream 288.

When recalculating 404 a load statistic, storage management process 10 may recalculate 410 a load statistic (e.g., counter 282) for list 276 to add the impact of e.g., data stream 288. Accordingly and in the event of subsequent requests to service other data streams, counter 282 associated with list 276 may be current and up-to-date (i.e., reflect the newly-added loading due to data stream 288), thus allowing for a more accurate comparison to the globally-generated counters associated with the other lists. Further and whenever a global update is performed, the previous global update calculations for a list (as well as any intermediary update calculations for a list) may be overwritten by the new calculations performed for the list during the global update process.

### An Existing Data Stream Ending:

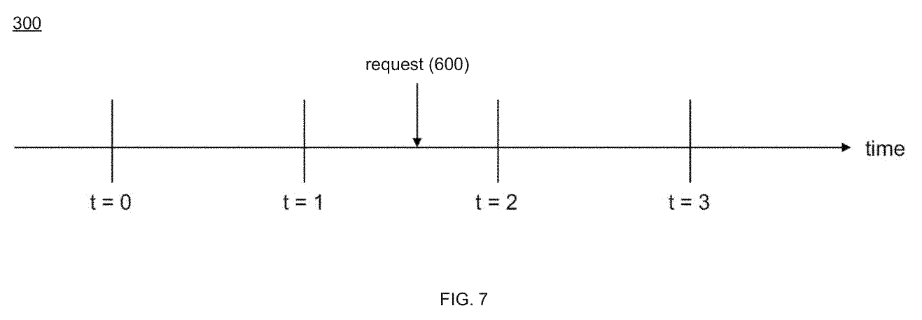

Referring also to FIG. 7 and for the following example, assume that an existing data stream (e.g., data stream 288) is ended because the writing of content 106 to storage device 200 has completed. Accordingly, storage management process 10 may receive 400 a request (e.g., request 600) concerning this load change event (i.e., the ending of data stream 288) that may impact at least one list (e.g., one or more of lists 276, 278, 280) defined for storage device 200. Specifically, one or more of the grid blocks defined within at least one list (e.g., one or more of lists 276, 278, 280) may no longer need to process data stream 288 and, therefore, these grid blocks (and the list(s) associated with these grid blocks) may experience a lower level of loading after the processing of data stream 288 is completed.

Specifically and when processing 402 the load change event (i.e., the ending of data stream 288), storage management process 10 may disassociate 412 a data stream from a list. Continuing with the above-stated example in which storage management process 10 previously selected 406 list 276 so that data stream 288 may be associated 408 with list 276 and a grid block defined therein may service data stream 288, storage management process 10 may now disassociate 412 data stream 288 from list 276 (since data stream 288 has ended).

When recalculating 404 a load statistic, storage management process 10 may recalculate 414 a load statistic (e.g., counter 282) for list 276 to remove the impact of data stream 288. Accordingly and in the event of subsequent requests to service other data streams, counter 282 associated with list 276 may be current and up-to-date (i.e., to no longer reflect the loading of data stream 288), thus allowing for a more accurate comparison to the globally-generated counters associated with the other lists. Again, whenever a global update is performed, the previous global update calculations for a list (as well as any intermediary update calculations for a list) may be overwritten by the new calculations performed for the list during the global update process.

### An Existing Data Stream Moving:

For the following example, assume that a new data stream (e.g., data stream 290) is established for the writing of content 274 to storage device 200. Further assume that while writing content 274 to a first grid block defined within a list, this first grid block reaches capacity (i.e., can store no additional portions of content 274). Accordingly, data stream 290 may need to be moved to a second grid block within the same list or another list.

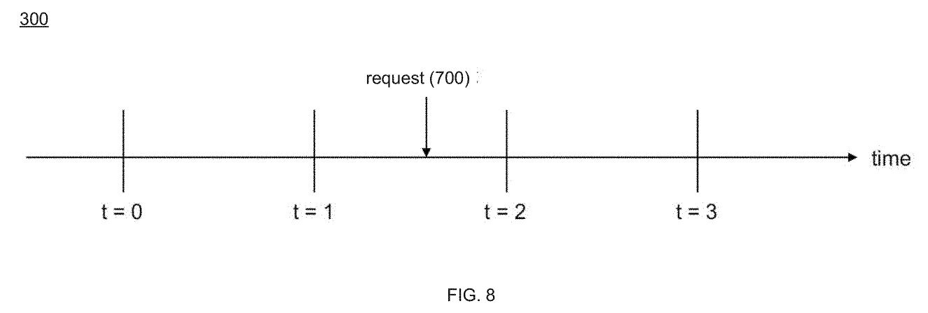

Accordingly and referring also to FIG. 8, storage management process 10 may receive 400 a request (e.g., request 700) concerning this load change event (i.e., the movement of data stream 290) that may impact at least one list (e.g., one or more of lists 276, 278, 280) defined for storage device 200. Specifically, one or more of the grid block (e.g., the first grid block) defined within at least one list (e.g., one or more of lists 276, 278, 280) may no longer need to process data stream 290 and, therefore, these grid blocks (and the list(s) associated with these grid blocks) may experience a lower level of loading after the processing of data stream 290 is moved away from these grid blocks. Further, one or more other grid blocks defined within at least one list (e.g., one or more of lists 276, 278, 280) may now need to process data stream 290 and, therefore, these grid blocks (and the list(s) associated with these grid blocks) may experience a higher level of loading after the processing of data stream 290 is moved to these grid blocks.

Specifically and when processing 402 the load change event (i.e., the movement of data stream 290), storage management process 10 may move 416 data stream 290 from a first list to a new target.

For the following example, assume that data stream 290 is currently being serviced by a grid block (e.g., grid block 240) defined within list 278. However, grid block 240 is now full and, therefore, can no longer service data stream 290. Accordingly and upon storage management process 10 receiving 400 request 700 concerning the movement of data stream 290, storage management process 10 may move 416 data stream 290 from list 278 to a new target identified by storage management process 10.

Accordingly, storage management process 10 may recalculate 414 a load statistic for (in this example) list 278 to remove the impact of data stream 290; may select 418 a new target; and may recalculate 410 a load statistic for the new target to add the impact of data stream 290.

Accordingly, storage management process 10 may recalculate 414 a load statistic (e.g., counter 284) for list 278 to remove the impact of data stream 290. Therefore, counter 284 associated with list 278 may be current and up-to-date (i.e., to no longer reflect the loading of data stream 290), thus allowing for a more accurate comparison to the counters associated with the other lists. Further, storage management process 10 may examine the counters (e.g., counters 282, 284, 286) associated with the above-described lists (e.g., lists 276, 278, 280) to determine the loading of the lists (e.g., lists 276, 278, 280) and, therefore, the grid blocks defined therein, so that storage management process 10 may select 418 a new target (i.e., for data stream 290) that is currently not experiencing a high level of loading. Assume for illustrative purposes that counter 286 indicates that list 280 (and the grid blocks defined therein) is currently the least utilized. Accordingly, storage management process 10 may select 418 list 280 so that data stream 290 is associated with list 280 and a grid block defined therein may resume the servicing of data stream 290. Storage management process 10 may recalculate 410 a load statistic (e.g., counter 286) for list 280 to add the impact of e.g., data stream 290. Accordingly and in the event of subsequent requests to service other data streams, counter 286 associated with list 280 may be current and up-to-date (i.e., reflect the newly-added loading due to data stream 290), thus allowing for a more accurate comparison to the globally-generated counters associated with the other lists. Again, whenever a global update is performed, the previous global update calculations for a list (as well as any intermediary update calculations for a list) may be overwritten by the new calculations performed for the list during the global update process.

While the above discussion concerned the “new target” being list 280 (after grid block 240 within list 278 became full), this is for illustrative purposes only and is not intended to be a limitation of this disclosure. Specifically, it is understood that the “new target” could actually be a different grid block within the same list. For example, assume that after grid block 240 within list 278 became full, storage management process 10 determines that list 278 is still the least utilized of all of the available lists. Accordingly, the “new target” may actually be the same list (i.e., list 278), albeit a different grid block within list 278.

While the above discussion concerned various ways in which the above-described counters may be updated, this is for illustrative purposes only and is not intended to be a limitation of this disclosure, as other configurations are possible.

For example, local updates may be computed in a fashion similar to the manner in which global updates are computed. Accordingly and for any local update within a time window: a) normalized data I/Os may be computed; b) the list counters may be updated; and c) if requested, a new grid block may be picked from the list that has the lowest counter value. In such a configuration, read and write counters may not be decayed when computing local updates. Such a configuration has the benefit of higher accuracy (since normalized data I/Os accumulated up to the time of update for all data streams and lists are used in computing the new list); while being burdened with higher computational complexity.

As another example, there may be no local updates. Accordingly and in such a configuration: a) the list counters may be sorted after each global update; and b) a new grid block for writing may be picked from the lists in a round-robin fashion (e.g., from the list with the lowest counter value to the list with the highest counter value). Such a configuration has the benefit of being simple to implement; while being burdened with inaccuracy (since data I/Os accumulated within a time window are completely ignored when making the selection decision).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method, executed on a computing device, comprising:
receiving a request concerning a load change event impacting at least one list defined for a storage device, each of the at least one list having one or more associated counters configured to monitor one or more grid blocks defined within the at least one list, wherein monitoring the one or more grid blocks includes indicating a quantity of data cumulatively read from the one or more grid blocks defined within the at least one list;
processing the load change event; and
recalculating a load statistic associated with the at least one list defined for the storage device.

2. The computer-implemented method of claim 1 wherein processing the load change event includes:
disassociating a data stream from a first list.

3. The computer-implemented method of claim 2 wherein recalculating the load statistic includes:
recalculating the load statistic for the first list to remove an impact of the data stream.

4. The computer-implemented method of claim 1 wherein processing the load change event includes:
selecting a second list; and
associating a data stream with a second list.

5. The computer-implemented method of claim 4 wherein recalculating the load statistic includes:
recalculating the load statistic for the second list to add an impact of the data stream.

6. The computer-implemented method of claim 1 wherein processing the load change event includes:
moving of an existing stream a first list to a new target.

7. The computer-implemented method of claim 6 wherein recalculating the load statistic includes:
recalculating the load statistic for the first list to remove an impact of the existing data stream;
selecting the new target; and
recalculating the load statistic for the second list to add an impact of the existing data stream.

8. A computer program product residing on a non-transitory computer readable medium having a plurality of instructions stored thereon which, when executed by a processor, cause the processor to perform operations comprising:
receiving a request concerning a load change event impacting at least one list defined for a storage device, each of the at least one list having one or more associated counters configured to monitor one or more grid blocks defined within the at least one list, wherein monitoring the one or more grid blocks includes indicating a quantity of data cumulatively read from the one or more grid blocks defined within the at least one list;
processing the load change event; and
recalculating a load statistic associated with the at least one list defined for the storage device.

9. The computer program product of claim 8 wherein processing the load change event includes: disassociating a data stream from a first list.

10. The computer program product of claim 9 wherein recalculating the load statistic includes:
recalculating the load statistic for the first list to remove an impact of the data stream.

11. The computer program product of claim 8 wherein processing the load change event includes:
selecting a second list; and
associating a data stream with a second list.

12. The computer program product of claim 11 wherein recalculating the load statistic includes:
recalculating the load statistic for the second list to add an impact of the data stream.

13. The computer program product of claim 8 wherein processing the load change event includes:
moving of an existing stream a first list to a new target.

14. The computer program product of claim 13 wherein recalculating the load statistic includes:
recalculating the load statistic for the first list to remove an impact of the existing data stream;
selecting a new target; and
recalculating the load statistic for the second list to add an impact of the existing data stream.

15. A computing system including a processor and memory configured to perform operations comprising:
receiving a request concerning a load change event impacting at least one list defined for a storage device, each of the at least one list having one or more associated counters configured to monitor one or more grid blocks defined within the at least one list, wherein monitoring the one or more grid blocks includes indicating a quantity of data cumulatively read from the one or more grid blocks defined within the at least one list;
processing the load change event; and
recalculating a load statistic associated with the at least one list defined for the storage device.

16. The computing system of claim 15 wherein processing the load change event includes:
disassociating a data stream from a first list.

17. The computing system of claim 16 wherein recalculating the load statistic includes:
recalculating the load statistic for the first list to remove an impact of the data stream.

18. The computing system of claim 15 wherein processing the load change event includes:
selecting a second list; and
associating a data stream with a second list.

19. The computing system of claim 18 wherein recalculating the load statistic includes:
recalculating the load statistic for the second list to add an impact of the data stream.

20. The computing system of claim 15 wherein processing the load change event includes:
moving of an existing stream a first list to a new target.

21. The computing system of claim 20 wherein recalculating the load statistic includes:
recalculating the load statistic for the first list to remove an impact of the existing data stream;
selecting the new target; and
recalculating the load statistic for the second list to add an impact of the existing data stream.
